(19) United States
(12) Patent Application Publication
(10) Pub. No.: US 2016/0368828 A1
(43) Pub. Date: Dec. 22, 2016

(54) METHOD FOR SINTERING WORKPIECES TO BE SINTERED, AND SYSTEM FOR THIS PURPOSE

(71) Applicant: EISENMANN SE, Böblingen (DE)

(72) Inventor: Axel Weiand, Ammerbuch (DE)

(21) Appl. No.: 14/902,424

(22) PCT Filed: Jul. 1, 2014
(86) PCT No.: PCT/EP2014/001795

§ 371 Date: Dec. 31, 2015

(30) Foreign Application Priority Data
Jul. 1, 2013 (DE) 10 2013 010 885.3

(51) Int. Cl. C04B 37/00; C04B 37/02

(52) U.S. Cl. CPC C04B 37/001; C04B 37/021; C04B 2237/402; C04B 2237/32

(57) ABSTRACT

In a method for sintering workpieces to be sintered, the workpieces to be sintered are debindered in an oxygen-free or at least oxygen-reduced inert gas atmosphere, wherein a debindering atmosphere is generated which is loaded with binding auxiliaries that are released from the workpieces to be sintered during the debindering process. The workpieces to be sintered are brought to a sintering temperature, wherein a sintering discharge gas is generated, and the workpieces to be sintered are cooled in a controlled manner. The sintered workpieces are debindered in a separate debindering chamber and sintered in a separate sintering chamber. The invention further relates to a system for sintering workpieces to be sintered.

The invention relates to a method for sintering workpieces to be sintered, in which the following steps are carried out:
a) the workpieces to be sintered are debinded in an oxygen-free or at least oxygen-reduced inert gas atmosphere, wherein there is generated a debinding atmosphere which is loaded with binding auxiliaries released from the workpieces to be sintered during debinding;
b) the workpieces to be sintered are brought to the sintering temperature, wherein a sintering waste gas is generated;
c) the sintered workpieces are cooled in a controlled manner.

The invention relates in addition to a system for sintering workpieces to be sintered, having
a) a debinding region in which the workpieces to be sintered are debinded in an oxygen-free or at least oxygen-reduced inert gas atmosphere, wherein there is generated a debinding atmosphere which is loaded with binding auxiliaries released from the workpieces to be sintered during debinding;
b) an inert gas device by means of which the inert gas atmosphere is produced and guided into the debinding region;
c) a sintering region in which, after the debinding, the workpieces to be sintered are brought to the sintering temperature, wherein a sintering waste gas is generated;
d) a cooling region in which the sintered workpieces are cooled in a controlled manner after sintering.

The sintering of workpieces to be sintered is of great importance in many technical fields, but in particular in the automotive industry. Workpieces made of so-called high-temperature materials, such as ceramics or aluminium-based materials, are of great interest in particular.

During compression of the workpieces to be sintered, binding auxiliaries are required, and these must be removed again completely before the actual sintering operation. Such debinding of the workpieces to be sintered is carried out by heating the workpieces to be sintered to a temperature at which the binding auxiliaries are released from the workpieces to be sintered and removed therefrom. Under a normal atmosphere, exothermic and endothermic reactions thereby take place inside the workpieces to be sintered, which reactions result in high local temperature differences within the structure of the workpieces to be sintered, which in turn can damage the workpieces to be sintered or considerably reduce the quality of the sintered product that is ultimately obtained.

In order to reduce such reactions, the debinding is in some cases carried out in an oxygen-free or at least oxygen-reduced atmosphere. Depending on the material to be sintered, residual oxygen contents of up to 20 vol. % may still be acceptable. Preferably, the residual oxygen content is not more than 15 vol. %, more preferably not more than 10 vol. % and particularly preferably not more than 5 vol. %. The inert gas atmosphere can be formed, for example, by a corresponding addition of nitrogen. Alternatively, the inert gas can also be formed by removing the oxygen from a base atmosphere by combustion.

A method of the type mentioned at the beginning can be carried out in continuous sintering furnaces, in which the workpieces to be sintered are guided continuously through a debinding section, a sintering section and a cooling section which are arranged in succession and without spatial atmosphere separation. Alternatively, it is known, for example, from EP 1 036 048 B1 to carry out the debinding, sintering and cooling of the workpieces to be sintered in a single furnace chamber; such a sintering furnace is also referred to as a 1-chamber furnace.

However, the required temperature profile, and in particular the minimum required temperature, is different for the debinding process and the sintering process. For example, the temperatures during sintering are considerably higher than during debinding; accordingly, the sintering temperature can be 1000° C. or more above the temperature for debinding; the required sintering temperatures can generally be achieved only by means of gas burners. In addition, a particularly uniform temperature distribution is desirable for the debinding.

It is very difficult to comply with those requirements especially in the case of 1-chamber furnaces. The uniform temperature distribution which is desirable for the debinding can be achieved particularly successfully with recirculating air operation. However, the components to be provided therefor are generally not able to withstand the temperatures that occur in the sintering process.

In addition, the single chamber must repeatedly be heated to the relatively high temperatures for the debinding process and then to the high temperatures for the sintering process, cooled again for cooling and then heated again for the next cycle. This requires a comparatively large amount of energy.

The object of the invention is, therefore, to provide a method and a sintering system of the type mentioned at the beginning which take account of the above considerations and with which sintered products of sufficient quality can be obtained with a better energy balance. In particular, a uniform temperature distribution during the debinding is to be possible.

The object is achieved in a method of the type mentioned at the beginning in that
d) the workpieces to be sintered are debinded in a separate debinding chamber and sintered in a separate sintering chamber.

According to the invention, the debinding and the sintering, and the atmospheres present in each case, can accordingly be spatially separated from one another. In the separate chambers, the temperature profile for the workpieces to be sintered can be adapted particularly well to the requirements of the workpieces to be sintered for each of the processes of debinding and sintering. In addition, the debinding chamber and the sintering chamber can thereby be matched to one another in such a manner that the dwell time of the workpieces to be sintered in the two chambers is of equal length, so that it is possible to carry out the method virtually continuously.

By separating the individual processes into different chambers, the sintering chamber can be operated independently of the debinding chamber and can have a different furnace design. The sintering chamber can optionally be operated as a muffle furnace.

In this context, and with regard to the above-mentioned object, it is particularly advantageous that the debinding chamber can be operated in recirculating air operation. The required uniform temperature distribution for the debinding process can be achieved particularly effectively by a recirculating air operation. In continuously operated continuous sintering furnaces, on the other hand, it is very difficult, for example, to design the system as a recirculating air system because the high temperatures required for the sintering process can be achieved only with difficulty in the case of recirculating air operation.

The overall length of the individual chambers can be kept small if the workpieces to be sintered are conveyed intermittently through the debinding chamber and the sintering chamber.

It is likewise generally necessary to apply a comparatively large amount of energy to produce the inert gas atmospheres in the individual chambers. It is therefore advantageous if there is used to produce the inert gas atmosphere or as the inert gas atmosphere a waste gas from a thermal after-burning device, which waste gas is obtained by combustion of the debinding atmosphere.

This is based on the finding that a two-fold benefit can be derived from the combustion of the debinding atmosphere loaded with binding auxiliaries. On the one hand, disposal of the binding auxiliaries released from the workpieces to be sintered is taken care of. On the other hand, the waste gas obtained in this thermal after-burning provides a gas having such a low oxygen content and, with reference to the debinding process, such inert properties that the waste gas can be used as the inert gas atmosphere for the debinding process. The waste gas can at least contribute to the inert gas atmosphere, which is then produced, for example, by mixing the waste gas from the thermal after-burning device with a fresh inert gas. It is thereby possible at least to reduce the proportion of fresh inert gas, which likewise improves the energy balance of the system.

Moreover, it is particularly advantageous if the sintering waste gas is additionally used to produce the inert gas atmosphere.

This is based on the additional finding that the sintering waste gas generated in the sintering process also has properties on the basis of which it can be used to produce the inert gas atmosphere for the debinding. The sintering process, for its part, is always carried out in its own inert gas atmosphere. That inert gas can accordingly be reused for the debinding region and accordingly can be utilised twice.

Depending on the properties of the sintering waste gas, in order to produce the inert gas atmosphere,
a) the sintering waste gas can be burned together with the debinding atmosphere in the thermal after-burning device to form the waste gas thereof; this is the case in particular when the oxygen content of the sintering waste gas is above the permitted threshold value for the inert gas atmosphere.

In addition, during the sintering, different substances or compounds that interfere with the debinding process can be released from the materials to be sintered. Such substances and impurities are likewise removed in the thermal after-burning device.

Alternatively,
b) the sintering waste gas can be mixed with the waste gas of the thermal after-burning device; this is the case in particular when the oxygen content of the sintering waste gas is below the permitted threshold value for the inert gas atmosphere.

Accordingly, the sintering waste gas is optionally sufficiently pure that no substances or compounds that interfere with the debinding process are present. In this case, the heat energy of the sintering waste gas can effectively be used since it can additionally heat the waste gas of the thermal after-burning device and thus contribute to the production and maintenance of the temperature that is required in the debinding chamber. To that end, the sintering waste gas is discharged from the sintering chamber via one or more outlet openings.

In all variants, the debinding atmosphere, the sintering waste gas and/or the waste gas obtained from the thermal after-burning device can additionally be conditioned. In particular, the temperature and the residual oxygen content can thereby be adjusted.

The above-mentioned object is achieved in the case of a system of the type mentioned at the beginning in that
e) a separate debinding chamber, in which the workpieces to be sintered are debinded, and a separate sintering chamber, in which the workpieces to be sintered are sintered, are provided.

The advantages of this feature of the system and those mentioned hereinbelow correspond analogously to the advantages which have been described above in relation to the method.

With regard to the adjustment of the temperature profiles, it is consequently advantageous if the debinding chamber is in the form of a recirculating air chamber. The sintering chamber can optionally be in the form of a muffle furnace, for example.

It is additionally advantageous if the workpieces to be sintered can be conveyed through the debinding chamber and the sintering chamber intermittently by means of a conveyor system.

Preferably, the inert gas device comprises a thermal after-burning device to which debinding atmosphere can be fed via a line and in which a waste gas is obtained by combustion of the debinding atmosphere, which waste gas can be used to produce the inert gas atmosphere or as the inert gas atmosphere for the debinding region.

Advantageously, in order to produce the inert gas atmosphere,
a) the sintering waste gas can be guided via an outlet line to the thermal after-burning device, where it can be burned together with the debinding atmosphere to form the waste gas thereof;

or
b) the sintering waste gas can be guided via an outlet line to the waste gas of the thermal after-burning device and can be mixed therewith.

Embodiments of the invention will be described in greater detail below with reference to the drawings, in which:

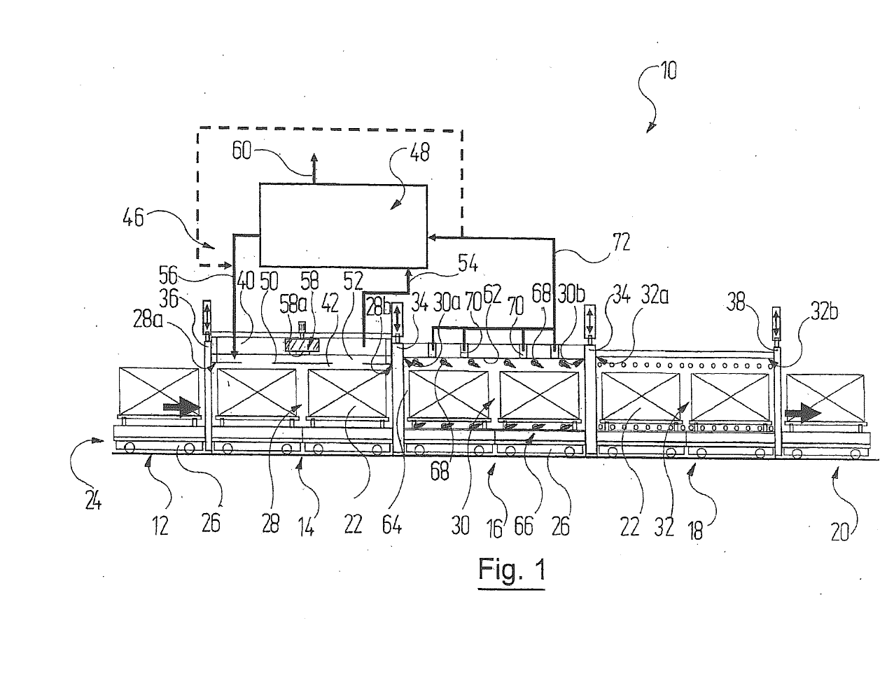

FIG. 1 shows a vertical longitudinal section of a system for sintering workpieces to be sintered;

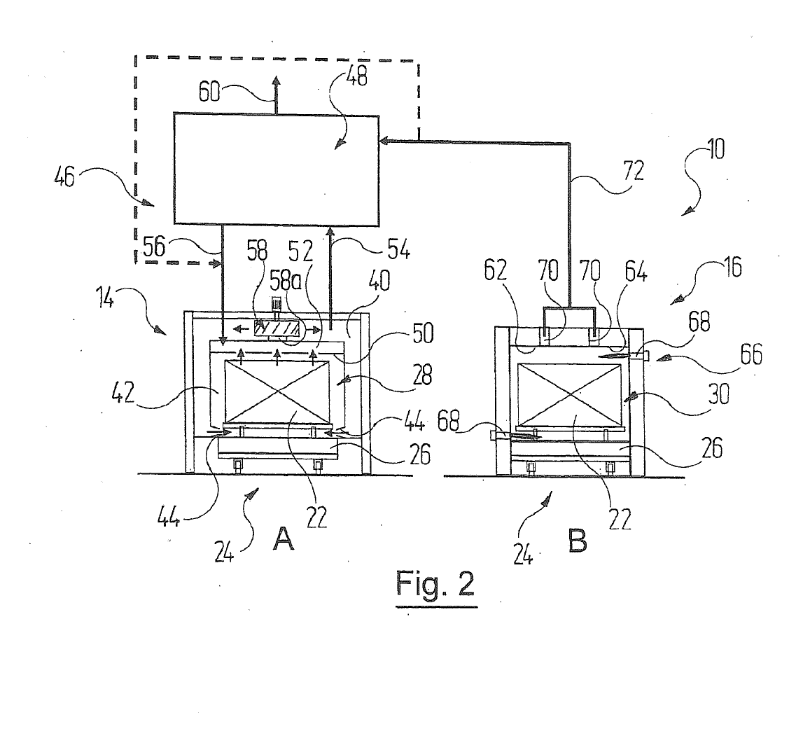

FIGS. 2A and 2B side by side show a vertical cross-section of a debinding chamber and a sintering chamber, respectively, of the sintering system;

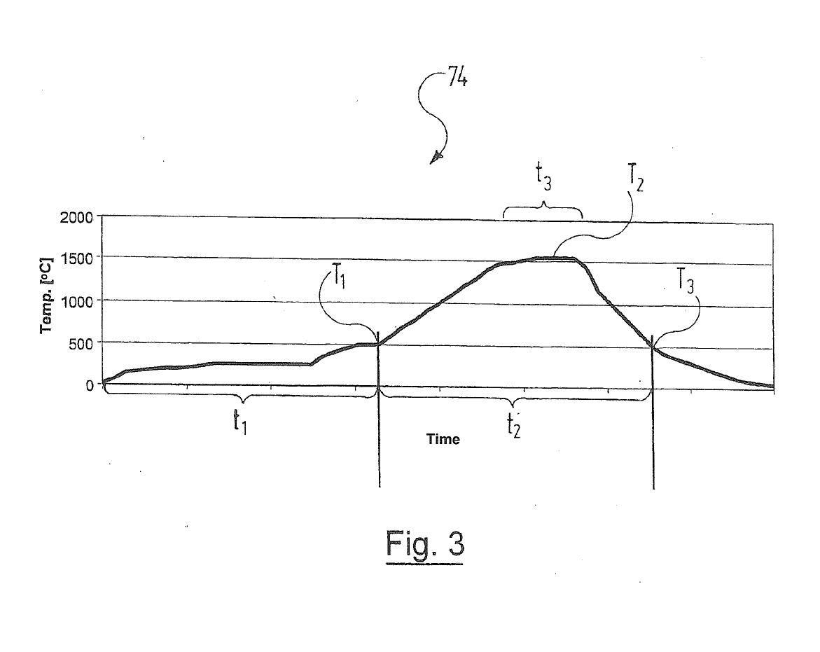

FIG. 3 shows a temperature profile during the process of sintering the workpieces to be sintered in the sintering system.

In FIG. 1, 10 designates as a whole a sintering system comprising an entry region 12, a debinding region 14, a sintering region 16, a cooling region 18 and an exit region 20.

In the sintering system 10, workpieces 22 to be sintered are sintered, which workpieces are to that end conveyed by means of a conveyor system 24 on conveyor trucks 26 from the entry region 12 through the individual regions 14, 16 and 18 for debinding, sintering and cooling to the exit region 20. In the figures, only some of the workpieces 22 to be sintered and the conveyor trucks 26 are provided with reference numerals.

The sintering system 10 comprises a separate debinding chamber 28, sintering chamber 30 and cooling chamber 32 for each of the individual process steps of debinding, sintering and cooling, each chamber having a chamber entry 28a, 30a and 32a and a chamber exit 28b, 30b and 32b, through which the workpieces 22 to be sintered pass intermittently in the present embodiment.

Between the debinding chamber 28 and the sintering chamber 30 and between the sintering chamber 30 and the cooling chamber 32 there is arranged in each case a movable intermediate partition 34 which keeps the respective atmospheres separate from one another and by means of which the associated temperature regions can be isolated from one another so that the debinding region 14, the sintering region 16 and the cooling region 18 and the atmospheres therein can be spatially separated from one another. The individual steps of debinding, sintering and cooling are accordingly each carried out in spatially separate regions in atmospheres which are separate from one another.

The intermediate partitions 34 can be moved between a corresponding closed position and an open position, whereby in the open position a respective passage for the workpieces 22 to be sintered from the debinding chamber 28 into the sintering chamber 30 or from the sintering chamber 30 into the cooling chamber 32 is created.

At the chamber entry 28a of the debinding chamber 28 there is arranged an entry partition 36 which is movable in a corresponding manner, while the chamber exit 32b of the cooling chamber 32 can be closed or opened by a comparable exit partition 38.

The debinding chamber 28 is in the form of a recirculating air chamber and operates in recirculating air operation; to that end it comprises an outer flow space 40, visible in FIG. 2, which surrounds an inner debinding space 42 into which the flow space 40 opens via inlet openings 44 close to the bottom.

During the debinding, an oxygen-free or at least oxygen-reduced inert gas atmosphere is fed to the debinding space 42, in order to prevent the damage mentioned at the beginning by oxygen during debinding.

To that end, the sintering system 10 comprises an inert gas device 46 by means of which an oxygen-free or at least oxygen-reduced inert gas atmosphere suitable for the debinding process is produced, correspondingly conditioned and fed to the debinding space 42.

The inert gas device 46 in turn comprises a thermal after-burning device 48 in which the binding auxiliaries released from the workpieces 22 to be sintered in the debinding process are burned. The atmosphere so generated during the debinding process and loaded with binding auxiliaries is referred to herein as the debinding atmosphere.

This combustion yields waste gas which, optionally after further conditioning such as, for example, temperature adjustment, can be used to produce the inert gas atmosphere for the debinding chamber 28 or can be used overall as the inert gas atmosphere.

In order to provide a corresponding flow circuit, the debinding space 42 has a permeable ceiling 50 which leads to an evacuation space 52 which is arranged between the debinding space 42 and the flow space 40. The evacuation space 52 in turn leads to the flow space 40 again, which is connected via a line 54 to the thermal after-burning device 48 so that debinding atmosphere is able to flow from the flow space 40 to the thermal after-burning device 48. The waste gases thereof, optionally additionally conditioned, are then passed at least in part as inert gas atmosphere through a feed line 56 into the evacuation space 52.

For recirculating air operation, a fan 58 is additionally arranged in the upper region of the flow space 40. The fan 58 draws atmosphere from the evacuation space 52 via a suction pipe 58a. This atmosphere comprises on the one hand the debinding atmosphere, which comes from the debinding space 42 and is loaded with binding auxiliaries, and on the other hand the inert gas atmosphere which is guided from the thermal after-burning device 48 into the evacuation space 52.

The fan 58 conveys a portion of the atmosphere in the flow space 40 to the inlet openings 44 and via the inlet openings into the debinding space 42, where the atmosphere flows through the debinding space 42 from bottom to top and thereby takes up binding auxiliaries which are released from the workpieces 22 to be sintered. The remaining portion of the atmosphere in the flow space 40, and thus also debinding atmosphere from the debinding space 42, is discharged by the fan 58 via the line 54 to the thermal after-burning device 48.

The portion of the waste gas of the thermal after-burning device 48 that is not guided to the debinding chamber 28 is discharged via a discharge line 60, for example, via the top or is guided to a different location, where the waste gas can be used as the energy source or inert gas atmosphere.

In the present embodiment, the sintering chamber 30 of the sintering system 10 comprises a furnace space 62 with heat-insulating walls 64 which are brought to and maintained at temperature by means of a burner system 66 having a plurality of burners 68, so that the workpieces 22 to be sintered are heated to the required temperature for the sintering process largely by radiation heat as well as by convection. In the present embodiment, the burners 68 heat the space above and below the workpieces 22 to be sintered by means of open flames and to that end are arranged along the sintering chamber 30 at a level above and below the workpieces 22 to be sintered.

In the sintering process there are generated sintering waste gases, which are discharged via a plurality of outlet openings 70 in the ceiling of the sintering chamber 30 via an outlet line 72 for the production of the inert gas atmosphere for the debinding chamber 28.

The sintering waste gases are guided to the thermal after-burning device 48, where they are burned together with the atmosphere from the debinding chamber 28 to form the inert gas atmosphere for the debinding space 42.

The sintering waste gases from the sintering process can optionally contribute as such to the inert gas atmosphere for the debinding space 42, without the sintering waste gases having to be burned or otherwise conditioned for that purpose. In this case, the outlet line 72 can also open directly into the flow space 40 or into the feed line 56, where the sintering waste gases from the sintering chamber 30 are able to mix with the waste gases from the thermal after-burning device 48 to form the inert gas atmosphere for the debinding space 42. This is indicated in FIGS. 1 and 2 by a broken path of the outlet line 72.

The configuration of the cooling region 18 with the cooling chamber 32 is known per se. Before the sintered workpieces 22 are transferred from the sintering chamber 30 to the cooling chamber 32, the temperature therein is so adjusted that there is no or only a small temperature difference between the atmospheres in the sintering chamber 30 and the cooling chamber 32. On the one hand, this prevents the sintered workpieces 22 from being quenched, as it were, and, on the other hand, cooling of the furnace space 62 of the sintering chamber 30 by incoming atmosphere from the cooling chamber 32 is thus prevented.

In summary, the sintering system 10 works as follows:

In the entry region 12, the workpieces 22 to be sintered are placed onto the conveyor truck 26 of the conveyor system 24 and introduced into the debinding chamber 28 through the entry partition 36. By means of the correspondingly conditioned inert gas atmosphere therein, the temperature required for the debinding is produced and binding auxiliaries are expelled from the workpieces 22 to be sintered.

The workpieces 22 to be sintered remain in the debinding chamber 28 for a time t₁, which is marked in a temperature profile 74 shown in FIG. 3, which illustrates the temperature profile of the workpieces 22 to be sintered as they pass through the sintering system 10. In the debinding chamber 28, the temperature of the workpieces 22 to be sintered rises to a temperature T₁, which in the present embodiment is approximately 500° C.

Owing to the recirculating operation of the debinding chamber 28, a uniform temperature exchange takes place, which ensures good temperature distribution in the workpieces 22 to be sintered and thus effective debinding.

When debinding is complete, the workpieces 22 to be sintered are transferred from the debinding chamber 28, with the intermediate partition 34 open, to the sintering chamber 30 and are there brought to the temperatures necessary for the sintering process.

The workpieces 22 to be sintered remain in the sintering chamber 30 for a time t₂ and are thereby first heated to their required sintering temperature T₂, at which they are maintained for a specific time t₃, before they are then cooled, still in the sintering chamber 30, to a lower T₃ again. The time t₃ is shorter than t₂ and can be, for example, less than a third of t₂.

In the present embodiment, the temperatures T₁ and T₂ at the start and at the end of the sintering process are equal. Specifically, the temperatures T₁ and T₃ in the present embodiment are 500° C., while the maximum sintering temperature T₂ is approximately 1550° C. However, T₁ and T₃ can also be different from one another.

The temperatures T₁, T₂ and T₃ and the times t₁, t₂ and t₃ depend in practice on the nature and properties of the workpieces 22 to be sintered and can vary accordingly.

After the required dwell time in the sintering chamber 30, the sintered workpieces 22 are conveyed through the intermediate partition 34 into the cooling chamber 32, where the now sintered parts 22 cool in a controlled manner. The cooled sintered workpieces 22 then leave the sintering system 10 via the exit partition 38 and are removed from the conveyor system 24 or transported to a different location. The mixing of temperatures and/or atmospheres during the transition from one chamber into another chamber are minimised by means of suitable measures or designs. Conventional lock devices, for example, can be provided for this purpose.

As can be seen from the temperature profile 74, the temperatures and temperature profiles for the two processes debinding and sintering can be matched to one another in such a manner that the workpieces 22 to be sintered must remain in the debinding chamber 28 and in the sintering chamber 30 for equal lengths of time and the times t₁ and t₂ are equal, so that an almost continuous throughput of the workpieces 22 to be sintered through the sintering system 10 is possible.

By means of the concept of using the waste gas obtained from the combustion of the debinding atmosphere, which is loaded with binding auxiliaries, as the inert gas atmosphere for the debinding chamber 28, it is possible overall to improve the energy balance of the sintering furnace.

In the sintering system 10 described above, the individual chambers 28, 30 and 32 are arranged immediately after one another. However, a design in which the chambers 28, 30, 32 can also be positioned side by side is also possible. In this case, the conveyor system 24 performs corresponding transverse conveying, and it may be necessary to provide lock devices in order to ensure that the atmospheres are kept separate, if required.

1. A method for sintering workpieces to be sintered, the steps comprising:
a) debinding workpieces to be sintered in an oxygen-free or at least oxygen-reduced inert gas atmosphere, wherein there is generated a debinding atmosphere which is loaded with binding auxiliaries released from the workpieces to be sintered during debinding;
b) bringing the workpieces to be sintered to a sintering temperature, wherein a sintering waste gas is generated;
c) cooling sintered workpieces in a controlled manner,
wherein
d) the workpieces to be sintered are debinded in a separate debinding chamber and sintered in a separate sintering chamber.

2. The method according to claim 1, wherein the debinding chamber is operated in recirculating air operation.

3. The method according to claim 1, wherein the workpieces to be sintered are conveyed intermittently through the debinding chamber and the sintering chamber by means of a conveyor system.

4. The method according to claim 1, wherein there is used to produce the inert gas atmosphere or as the inert gas atmosphere a waste gas from a thermal after-burning device, which waste gas is obtained by combustion of the debinding atmosphere.

5. The method according to claim 4, wherein the sintering waste gas is additionally used to produce the inert gas atmosphere.

6. The method according to claim 5, wherein, in order to produce the inert gas atmosphere,
a) the sintering waste gas is burned together with the debinding atmosphere in the thermal after-burning device to form the waste gas thereof;
or
b) the sintering waste gas is mixed with the waste gas of the thermal after-burning device.

7. A system for sintering workpieces to be sintered, comprising:
a) a debinding region in which the workpieces to be sintered are debinded in an oxygen-free or at least oxygen-reduced atmosphere, wherein there is generated a debinding atmosphere which is loaded with binding auxiliaries released from the workpieces to be sintered during debinding;
b) an inert gas device by means of which the inert gas atmosphere is produced and guided into the debinding region;
c) a sintering region in which, after the debinding, the workpieces to be sintered are brought to a sintering temperature, wherein a sintering waste gas is generated;
d) a cooling region in which the sintered workpieces are cooled in a controlled manner after sintering;
wherein
e) a separate debinding chamber, in which the workpieces to be sintered are debinded, and a separate sintering chamber, in which the workpieces to be sintered are sintered, are provided.

8. The system according to claim 7, wherein the debinding chamber (28) is in the form of a recirculating air chamber.

9. The system according to claim 7, wherein the workpieces to be sintered can be conveyed intermittently through the debinding chamber and the sintering chamber by means of a conveyor system.

10. The system according to claim 7, wherein the inert gas device comprises a thermal after-burning device to which debinding atmosphere can be fed via a line and in which a waste gas is obtained by combustion of the debinding atmosphere, which waste gas can be used to produce the inert gas atmosphere or as the inert gas atmosphere for the debinding region.

11. The system according to claim 10, wherein, in order to produce the inert gas atmosphere,
a) the sintering waste gas can be guided via an outlet line to the thermal after-burning device, where it can be burned together with the debinding atmosphere to form the waste gas thereof;
or
b) the sintering waste gas can be guided via an outlet line to the waste gas of the thermal after-burning device and can be mixed therewith.
